(19) United States
(12) Patent Application Publication
(10) Pub. No.: US 2013/0207423 A1
(43) Pub. Date: Aug. 15, 2013

(54) BICYCLE SEAT COVER WITH INTEGRATED STORAGE DEVICE

(71) Applicants: Janis Linda Russell, Traverse City, MI (US); M'Lynn Hartwell, Traverse City, MI (US)

(72) Inventors: Janis Linda Russell, Traverse City, MI (US); M'Lynn Hartwell, Traverse City, MI (US)

(21) Appl. No.: 13/372,818

(22) Filed: Feb. 14, 2012

(51) Int. Cl. B62J 1/20; B62J 9/00

(52) U.S. Cl. 297/188.2

(57) ABSTRACT

An integrated bicycle seat cover and storage device with a seat-conforming cover connected at a rear end to the outer edge of an opening of a weather-resistant storage receptacle adapted to be secured to a bike adjacent and below a rear end of the seat. In a first form the storage receptacle is an open pocket mounted on the closure flap of a bike bag, and an additional outer flap on the bike bag covers the storage receptacle. In an alternate form, the storage receptacle is a pouch with an integrated horizontal closure, and includes means for securing it directly to the bike adjacent and below the rear of the seat. The seat cover can be deployed over the storage receptacle and the seat from front to back when removed from the storage receptacle.

### BACKGROUND OF THE INVENTION

1. Field of the Invention

The invention is in the field of devices related to storing protective bicycle seat covers on bicycles.

2. Description of Related Art

It is a known difficulty to keep bicycle seats dry and protected from weather conditions when storing, parking, or transporting a bicycle outdoors. This difficulty is especially realized by cyclist commuters who rely on their bicycles as a means of transportation in rainy or snowy weather conditions. Oftentimes this problem is aggravated by bicycle seats made of permeable synthetic materials or leather, which can absorb water and which are easily damaged by rain or snow. Exposing bicycle seats to such weather conditions causes the seats to deteriorate, and results in an uncomfortable ride and wet clothing for riders.

For these reasons, among others, cyclists regularly use seat covers to protect their seats from rain and snow. Prior seat covers may be as simple as plastic bags, or they may be specifically manufactured and fitted for use as seat covers. Examples of specially designed bicycle seat covers are illustrated in U.S. Patent Application Publication No. 2011/0198903 to Sebastian (removable saddle cover constructed of elastomeric material), U.S. Patent Application Publication No. 2005/0110314 to Buselmeier (cycle seat cover with elastic ring-shaped band, Velcro® hook-and-loop fastener, or a tie cord to secure the cover to the seat), U.S. Pat. No. 4,319,781 to Tsuge.

A problem encountered when using prior seat covers occurs when a cyclist removes a seat cover and has no dry place to store the cover. The bicycle itself typically does not have any dry storage area where the cover can be quickly and easily stored. Further, many cyclists find it difficult or burdensome to carry a seat cover in clothing pockets or backpacks.

Some of the seat cover references cited above mention using a strap to attach the seat cover to a portion of the bicycle frame when the cover is not secured to the seat. The available locations of the bicycle frame for attaching the cover are generally limited to a cross bar or down tube location, as illustrated in FIG. 4 of Buselmeier. However, securing a seat cover to the cross bar and down tube locations can interfere with a cyclist's pedal stroke, and does not provide weather protection for the cover or allow the cover to dry. Alternately, when seat covers are stored in general bike bags, such as the one illustrated in U.S. Design Pat. No. 336,740 to Graf, there is not adequate ventilation for drying the seat covers. Also, using general bike bags to store seat covers can result in loss of the seat cover, or in damage to the cover from hand tools, bike locks, or other equipment stored in such bags.

Mechanical storage devices for seat covers have been designed for motorcycles. Examples of motorcycle seat covers and cover storage devices include U.S. Pat. No. 5,080,431 to Frazier (motorcycle seat cover retractable into spring loaded housing), U.S. Pat. No. 3,537,746 to Peters (motorcycle seat and fuel tank protective cover that is retractable into a storage container), and U.S. Pat. No. 1,853,742 to Owen et al. (motorcycle seat, fuel tank, handlebar, and fender rain guard to be wound on a roller). These seat cover storage devices are mechanical in nature, rigid, relatively heavy, and seemingly expensive to produce and adapt to a bicycle.

Other types of bicycle seat covers are large enough to cover other portions of a bicycle, making them more difficult to carry while riding and to secure to the bicycle. Examples of large covers include U.S. Pat. No. 5,676,288 to Spirk (protective cover for handlebars and seat), U.S. Pat. No. 5,372,169 to Norton et al. (protective cover for entire bicycle), and U.S. Pat. No. 5,445,200 to Celestino et al. (protective cover for entire bicycle).

U.S. Pat. No. 3,836,196 to Hu describes a seat cover that adapts to an existing bicycle seat or saddle with male button connections along its sides. The cover is secured along the sides of the saddle using the button connections. The protective portion of the cover is made up of two flaps that are secured along the sides of the saddle and that can be folded inward across the top of the seat cover and connected with a fastening means, such as a zipper. When the flaps are connected the cover claims to protect the saddle from rain or dew. When a rider wishes to use the saddle, the fastening means can be undone, allowing the flaps to be opened and hung along the sides of the saddle. These hanging flaps can interfere with a rider's pedal stroke and cause an uncomfortable ride.

U.S. Pat. No. 4,948,020 to Smith discloses a device that is made up of a rigid platform hingedly connected to a swing arm that is hingedly attached to a bicycle seat post. The platform can be pivoted between two horizontal positions. In one position the platform sits behind the bicycle seat and acts as a carrier rack. In the other position, the platform is pivoted upward over the seat one hundred eighty degrees, resting slightly above the seat to protect it from rain. This device can be large, relatively heavy, and seems to do a poor job of protecting a bicycle seat.

### SUMMARY OF THE INVENTION

We have invented an integrated seat cover and seat cover storage device that is lighter, simpler, more protective of the seat and seat cover, better drying, less expensive, and easier to use than prior devices, and which is specifically designed for use with a bicycle seat (hereafter, “seat” and “saddle” will be used interchangeably). The device comprises a protective seat cover attached to a ventilated storage receptacle that exclusively stores the seat cover. The storage receptacle includes bicycle attachment means for attaching the storage receptacle to a bicycle adjacent, and preferably underneath, a rear portion of a bicycle seat. When attached to the bicycle adjacent the rear portion of the seat, the seat cover can be deployed from the receptacle as needed to cover the seat from rear to front.

The seat cover has a generally seat-shaped body made from protective, flexible, fabric or fabric-like material, and the seat cover can be secured snugly to the seat, for example using an elastic outer edge, an elastomeric seat cover material, or a draw string snugged around its outer edge. The seat cover may also be used to display advertisements, lettering, trademarks, logos, or other designs. The seat cover is attached to outside edge of the storage receptacle to protect the opening when the seat cover is deployed, directing any water flow over the storage receptacle opening. And further, the seat cover may be detachable from the storage bag to allow for replacement or personalized seat covers to be adapted to the storage bag.

In a first form, the storage receptacle is located on the outside of a closure flap on a bike storage bag, and the bike storage bag is the bicycle attachment means. In this embodiment, an additional outer flap may be used to cover and secure the storage receptacle, which is raised to allow the seat cover to be deployed over the seat without disturbing the function of the bike storage bag.

In a further form, the storage receptacle is a pouch with a horizontal opening secured by Velcro® fasteners or other self-contained closure means on the pouch itself. In this embodiment, the seat cover is sewn or otherwise attached to the pouch, and the bicycle attachment means is formed on the pouch to attach the pouch directly to the bicycle adjacent a rear portion of the seat. The pouch may be attached to the top surface of a standard big bag using an adhesive secured Velcro® fastener.

Other aspects and advantages of the present invention will be readily appreciated upon review of the detailed description and the accompanying drawings.

### BRIEF DESCRIPTION OF THE DRAWINGS

FIG. 1 is a perspective side-rear view of a bicycle seat, with the seat cover and integrated storage device according to FIG. 1 attached thereto, and with the seat cover deployed over the bicycle seat from rear to front.

FIG. 2 is a perspective side-rear view of a bicycle seat, with a seat cover and integrated storage device according to the invention attached thereto adjacent a rear portion of the seat, showing the seat cover stored in the storage receptacle.

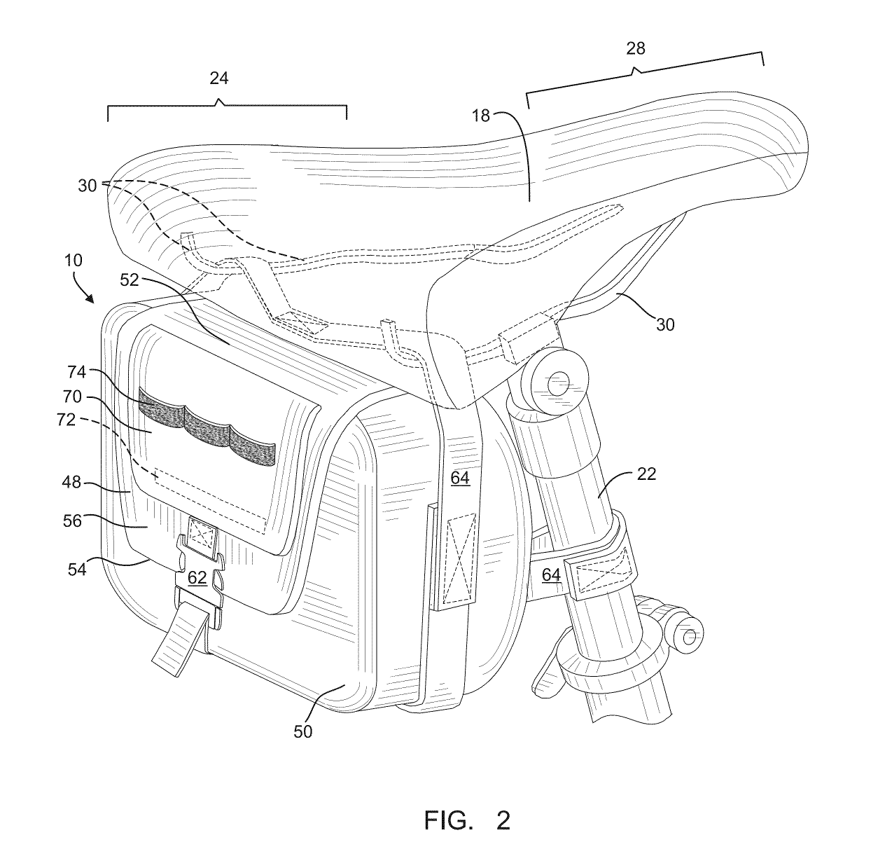

FIG. 3 is a perspective side-rear view of the seat cover and integrated storage device according to FIG. 1, unattached from the bicycle, and with the seat cover deployed and detached from the storage receptacle, but not covering a bicycle seat.

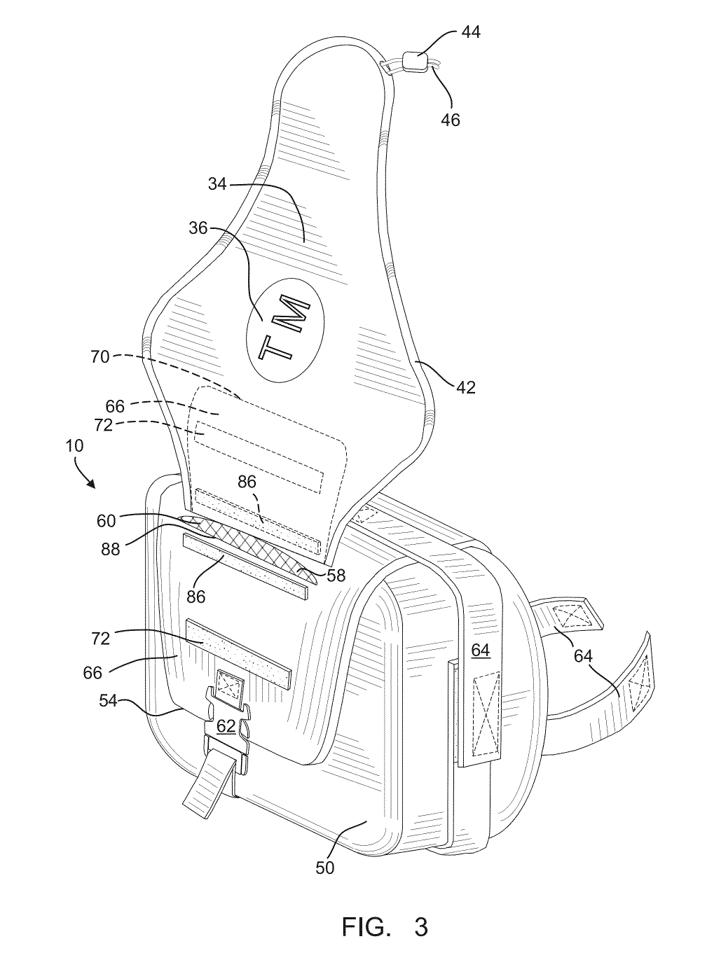

FIG. 4 is a perspective side-front view of the seat cover and integrated storage device according to FIG. 1, unattached from the bicycle, and with the seat cover stored in the storage receptacle.

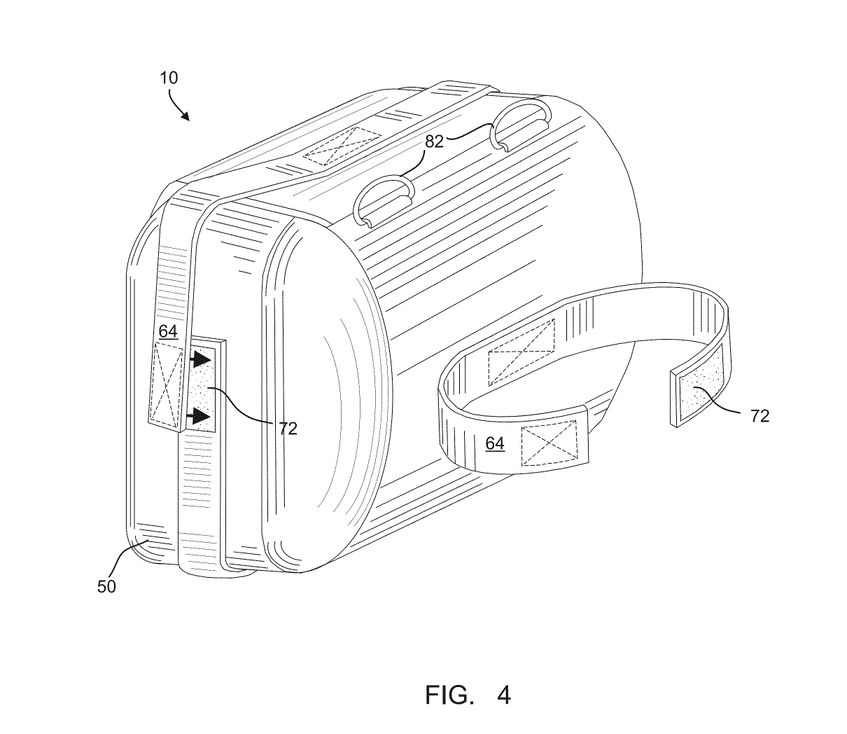

FIG. 5 is a side view of the seat cover and integrated storage device according to FIG. 1, attached to an alternate style of bicycle seat using D-ring hooks.

FIG. 6 is a side view of a bicycle seat, with an alternative embodiment of a seat cover and integrated storage device according to the invention attached thereto adjacent a rear portion of the seat, showing the seat cover stored in the storage receptacle.

FIG. 7 is a perspective side-rear view of the embodiment of FIG. 6, showing the seat cover deployed over the bicycle seat.

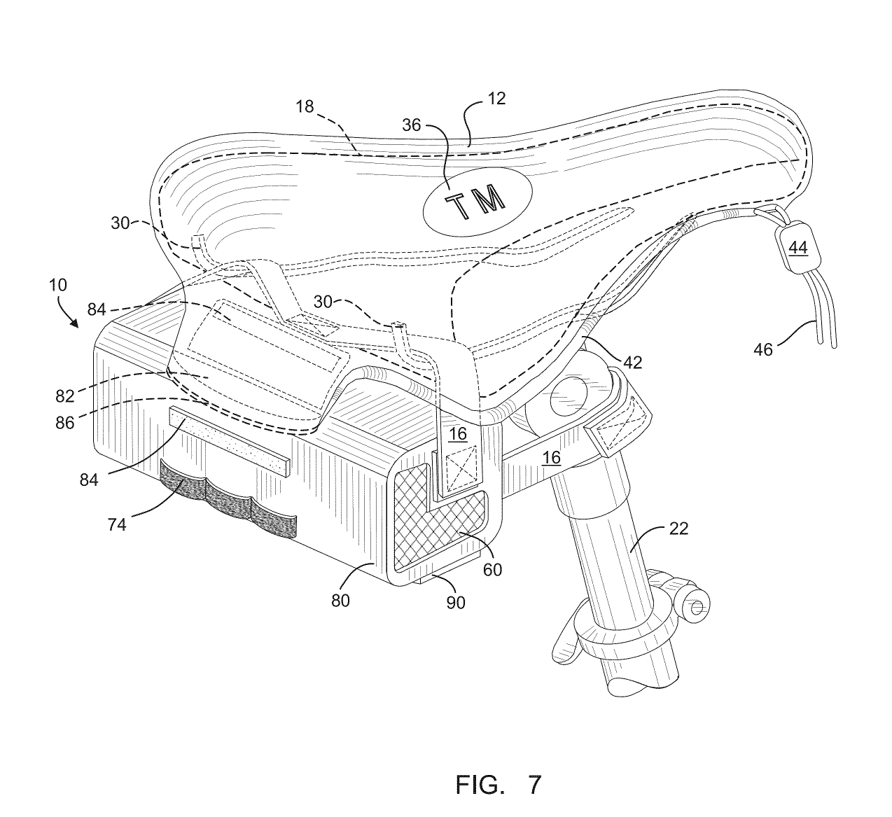

FIG. 8 is a perspective side-rear view of the embodiment of FIG. 1, showing the seat cover deployed over the bicycle seat and the inner bike bag flap open.

### DETAILED DESCRIPTION OF THE INVENTION

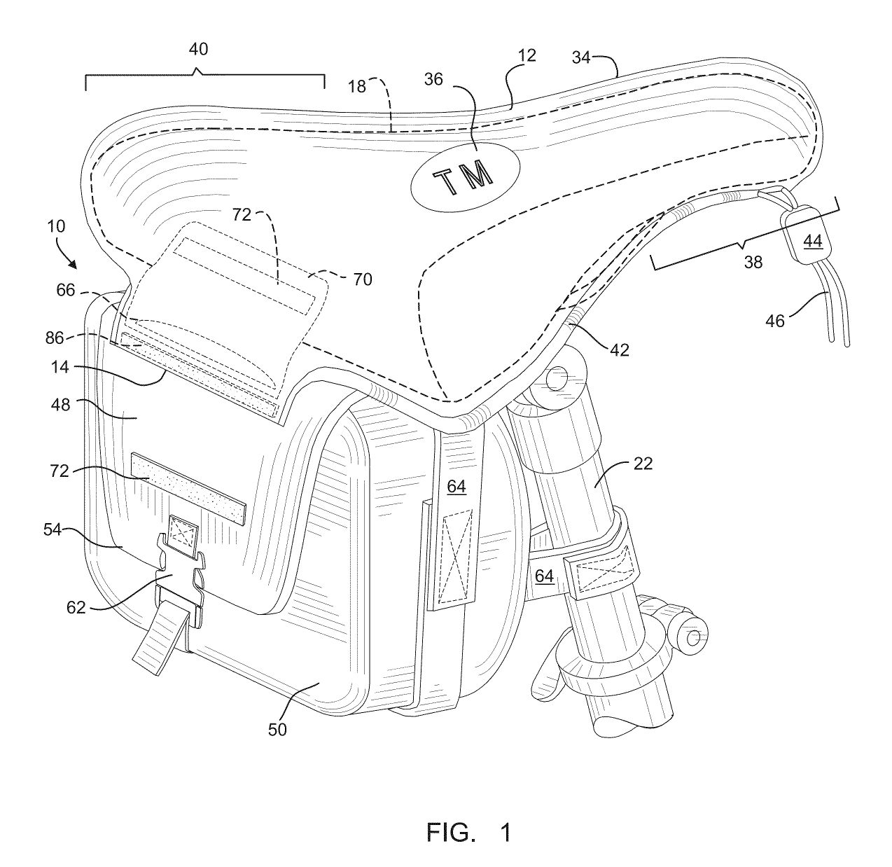

Referring to the Figures, wherein like numerals indicate like parts throughout the several views, an exemplary seat cover and integrated storage device 10 according to the invention is shown generally in FIG. 1. Device 10 includes a seat cover 12 that is attached to a storage receptacle 14 with means for attaching 16 the receptacle to the bicycle adjacent a rear portion 24 of a bicycle seat 18, for example to a seat connection assembly 20, to a seat post 22, or to a combination of the two.

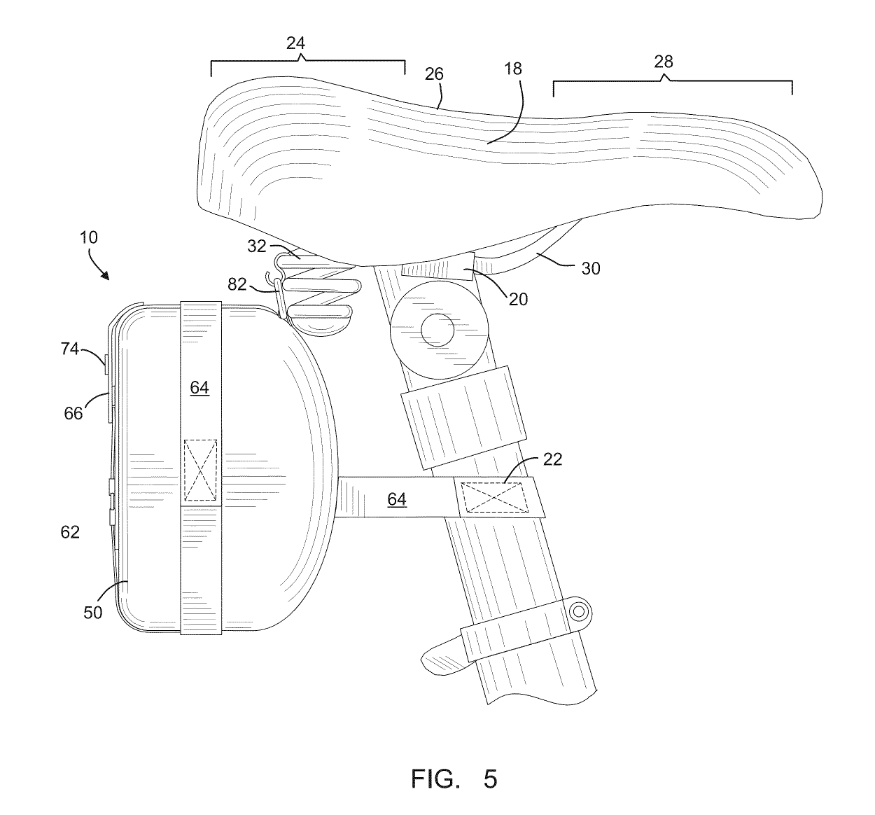

The illustrated seat 18 is a bicycle seat, although it could be the seat or saddle of other types of cycle—“bicycle seat cover” will be understood herein to include seat covers for such other types of cycle. Further, although the illustrated seat 18 is a common and known seat design, the described invention can be configured to accommodate many different styles and types of seat, for example racing seats or large cushioned seats or saddles, by sizing and shaping the seat cover portion 12 accordingly. The seat 18 has a sitting surface 26 that can be made of any material, including leather, vinyl, rubber, nylon, canvas, plastic, metal, and foam. The seat 18 has a rear portion 24 that generally narrows to a front portion 26. Opposing the sitting surface 26 is a connection assembly 20 to a seat post 22. The connection assembly 20 commonly includes a plurality of seat rails 30 (usually two) that extend from the rear portion 24 to the front portion 28 of the seat 18. Other seat designs, such as that illustrated in FIG. 5, may include a plurality of seat springs 32 (usually two) that attach to the rear portion 24 of the seat 18.

A device 10 according to the invention is illustrated in FIG. 1 in a preferred position adjacent and below the rear portion of the seat, with a seat cover 12 stored therein for covering and protecting the seat 18. Seat cover 12 has a generally triangular or seat-shaped body made from a suitable protective, flexible fabric or fabric-like material, or combinations of such materials. The seat cover 12 may be comprised of one layer or multiple layers of fabric or other materials, including, but not limited to, an elastomeric material, polyester fabric, Gore-Tex® fabric, nylon, canvas, plastic, cotton, leather. Seat cover 12 has an exterior surface 26 that is wind resistant, ultraviolet light resistant, mildew resistant, and water resistant (and preferably waterproof) and may be used to display advertisements, lettering, trademarks, logos, or other designs 36. The seat cover 12 may have added thickness to be used for cushioning or insulation purposes. The primary function of the seat cover 12 is to cover and protect the seat 18 from water, dirt, condensation, and precipitation of any kind.

Seat cover 12 has a front end 38 and a rear end 40. When the seat cover 12 is deployed over the seat 18 the front end 38 attaches to the front portion 28 of the seat, and accordingly, the rear end 40 attaches to the rear portion 24 of the seat. When coving the seat 18, the seat cover 12 is preferably tight fitting to the shape of the seat 18, but it may also be loose fitting. In the illustrated embodiments, seat cover 12 has an outer edge 42 that has a draw string 46 disposed along the outer edge 42 in a sewn crease with an adjustable clasp 44 located at the front end 38 to be use for cinching and securing the seat cover 12 to the seat 18. The clasp 44 may be located at any place along the outer edge 42, but preferably toward the front end 38. Other forms a securing element may be used in place of a draw string 46 and clasp 44, including but not limited to, an elastic member, elastic stitching, elastomeric material, Velcro® hook-and-loop fastener straps, tie cords, rubber bands, or button straps. The securing element is preferably secure enough to the seat 18 to resist wind from blowing off the cover, such as when a bike is transported on a motor vehicle.

The rear end 40 of the seat cover 12 is detachably connected to a storage receptacle 14. The seat cover 12 may be connected by being sewn directly to the storage receptacle 14 or by a strip of detachable Velcro® fasteners 86 or other means of detachable fasteners. The storage receptacle 14 encloses a storage volume large enough to receive the seat cover 12, and the storage receptacle 14 has a pocket opening 58 that allows the seat cover 12 to be fully inserted into and stored in the storage receptacle 14, and to be easily removed from the storage receptacle 14 (except for any portion secured to the interior) to deploy it over the seat 18. The seat cover 12 is preferably detachably connected to an outer edge 88 of the pocket opening 58, so the seat cover 12 covers the pocket opening 58 and keeps the storage receptacle 14 dry when deployed over the seat 18. The storage receptacle 14 may be partially or fully made of a material that allows for air circulation so the seat cover 12 can dry, such as mesh, netting, or a breathable fabric or fabric-like material.

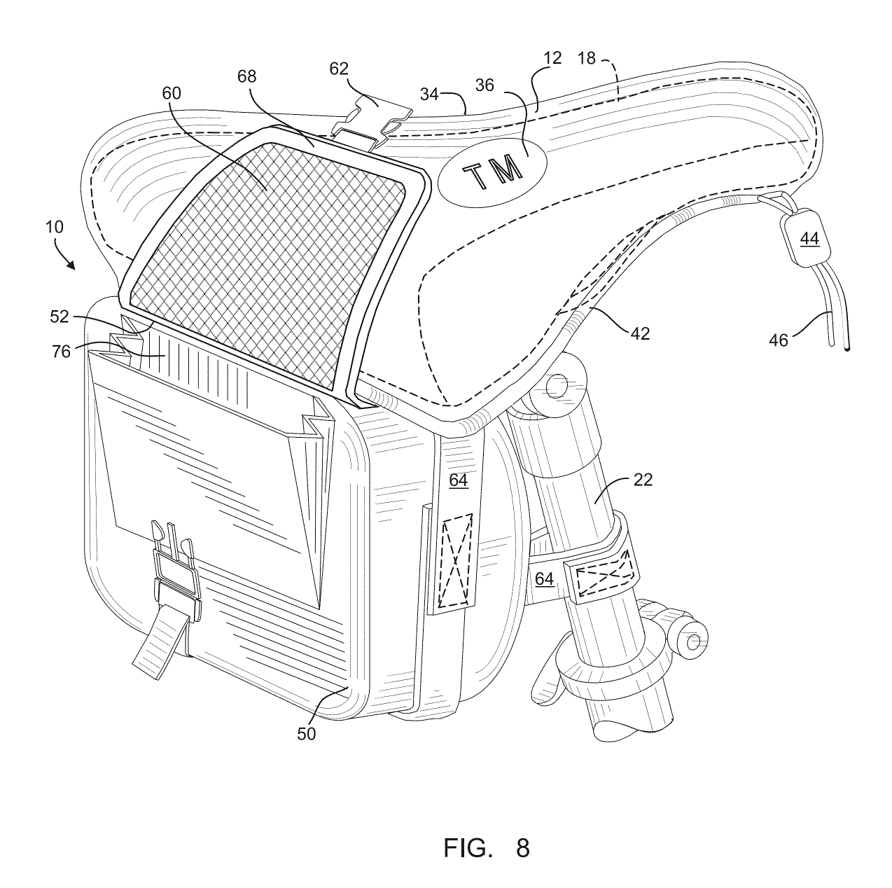

The storage receptacle 14 includes bicycle attachment means 16 for attaching the storage receptacle 14 to a bicycle adjacent, and preferably underneath, the rear portion 24 of a bicycle seat 18. In one embodiment, as illustrated in FIG. 1, the storage receptacle 14 is located on an “inner” flap 48 that is the outer or closure flap of an otherwise standard bike bag 50, and the bike bag is the bicycle attachment means 16. The inner flap 48 has a top edge 52, a bottom edge 54, a front side 56, and back side 68. The inner flap 48 is attached to the bike bag 50 along the top edge 52 of the inner flap 48. In this embodiment, the storage receptacle 14 is defined by the front side 56 of the inner flap 48 and a pocket 60 that is sewn or otherwise attached to the inner flap 48. The pocket 60 may be made of a different material from the inner flap 48, such as a mesh or netting, as illustrated in FIG. 8. The bottom edge 54 of the inner flap 48 is detachably secured to the bike bag 50 with a buckle clasp 62, or other closure means, such as Velcro® hook-and-loop fastener. The bike bag 50 is adapted to be secured to the lower rear portion of a bicycle seat 18. Specifically, the bike bag 50 may be secured to the seat rails 30, seat post 22, seat springs 32, and/or other portions of the seat connection assembly 20 by Velcro® hook-and-loop fastener straps 64, D-ring hooks 82, tie cords, button straps, or other securing devices.

In addition, in this embodiment, an outer flap 66 is sewn or otherwise attached at or near the top edge 52 of the inner flap 48 and extends over the pocket opening 58. The outer flap 66 protects the storage receptacle 14 and the seat cover 12 stored therein from water, dirt, or precipitation. The lower end 70 of the outer flap 66 may be detachably secured near the bottom edge 54 of the inner flap 48 preferably by Velcro® securing means 72 or by a buckle clasp or other securing means. A reflector strip 74 may also be fastened on the outer flap 66, inner flap 48, or other suitable location. The reflector strip 74 may be sewn as to create a loop of fabric to attach a flashing light or a carabiner.

Accordingly, the seat cover 12 is normally stored inside the pocket 60 with the outer flap 48 fastened protectively over the pocket opening 58. When a cyclist wants to deploy the seat cover 12, the outer flap's Velcro® securing means 72 is first released, allowing the outer flap 66 to be opened by raising the outer flap 66 to expose the pocket opening 58. The seat cover 12 may then be deployed through the pocket opening 58 of the storage receptacle 14 and extended over the pocket opening 58 and the seat 18. The outer flap 66 is retained in a position between the seat cover 12 and the bicycle seat 18. This leaves the inner flap 48 uncovered, allowing the interior of the bike bag 50 to be accessed when the seat cover 12 is in use. The bike bag 50 may be accessed by unclasping the buckle clasp 62 and raising the inner flap 48, as illustrated in FIG. 8.

When the seat cover 12 is removed from the bicycle seat 18, it may be rolled or otherwise gathered and inserted through the pocket opening 58 into the storage receptacle 14. The outer flap 66 may be then be closed over the pocket opening 58 and fastened to the bike bag 50 using the Velcro® securing means 72.

The storage device 10 should keep the seat cover 12 protected from the elements when stored, so that at least the inner surface or underside of the seat cover 12 remains dry in the pocket 60 before being deployed, regardless of weather and riding conditions. For this purpose the outer flap 48 and at least an exposed or lower portion of the pocket 60 can be made from water-resistant or waterproof material, while an unexposed or side portion of the pocket 60 can be made from a breathable mesh.

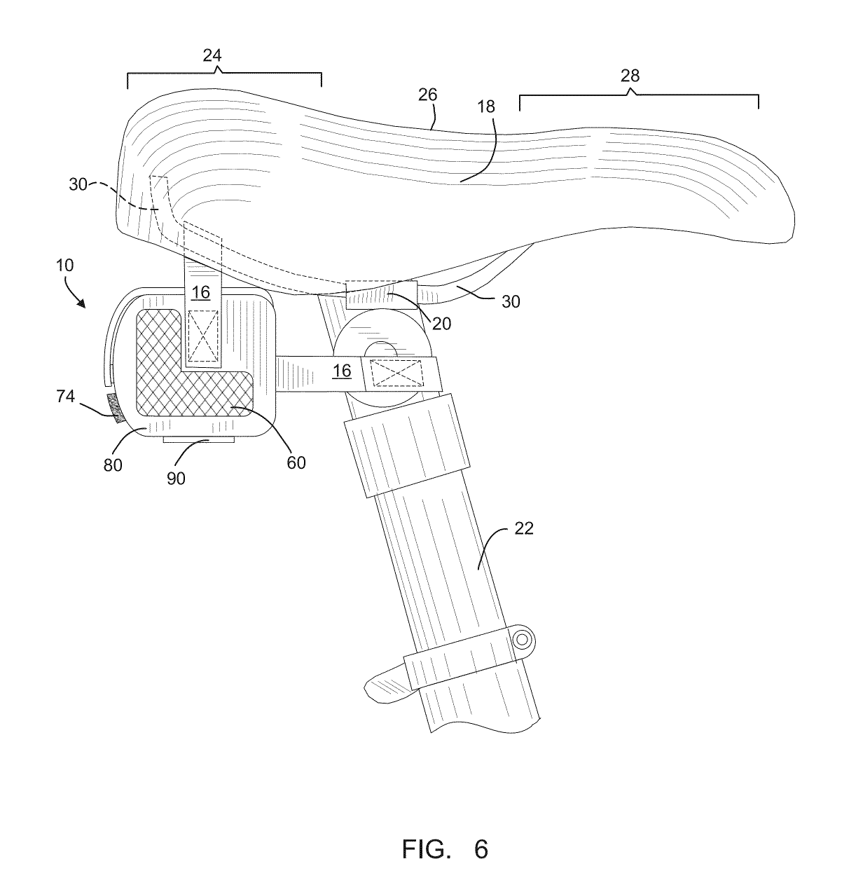

In another embodiment, as illustrated in FIG. 6, the storage receptacle 14 is defined by a simple pouch 80 having a body made of a fabric or fabric-like material with a horizontal opening 82 large enough to insert and remove the seat cover 12. The horizontal opening 82 may be closed and secured by a Velcro® hook-and-loop fastener 84 or other closure means integrated with the pocket 60. In this embodiment, the seat cover 12 is sewn or otherwise connected at its rear end 40 to the outer edge 88 of the horizontal opening 82, so the seat cover 12 covers the horizontal opening 82 and keeps the storage receptacle 14 dry when deployed over the seat 18. The pouch 80 also has Velcro® straps 16, D-ring hooks 82, or other attaching means for securing the pouch 80 to the seat rails 30, seat post 22, seat springs 32, and/or other portions of the seat connection assembly 20. The pouch 80 may also be removably attached to the top surface of a standard big bag using an adhesive secured Velcro® fastener 90.

Still referring to the embodiment of FIG. 6, when the seat cover 12 is ready to be removed from the storage receptacle 14, the Velcro® hook-and-loop fastener 84 or other closure means must be undone. The seat cover 12 may then be deployed from the horizontal opening 82 of the pouch 80 and extended over the seat 18. When the seat cover 12 is taken off the seat 18, it may be rolled or otherwise gathered and inserted through the horizontal opening 82 back into the storage receptacle 14. The horizontal opening 82 may then be closed and fastened with the Velcro® hook-and-loop fastener 84 or other closure means.

It will finally be understood that the disclosed embodiments are presently preferred examples of how to make and use the claimed invention, and are intended to be explanatory rather than limiting of the scope of the invention as defined by the claims below. Reasonable variations and modifications of the illustrated examples in the foregoing written specification and drawings are possible without departing from the scope of the invention as defined in the claim below. It should further be understood that to the extent the term “invention” is used in the written specification, it is not to be construed as a limited term as to number of claimed or disclosed inventions or the scope of any such invention, but as a term which has long been conveniently and widely used to describe new and useful improvements in technology The scope of the invention supported by the above disclosure should accordingly be construed within the scope of what it teaches and suggests to those skilled in the art, and within the scope of any claims that the above disclosure supports. The scope of the invention is accordingly defined by the following claims.

1. A bicycle seat cover and integrated storage device comprising:
a generally seat-shaped bicycle seat cover comprising a flexible material adapted to generally conform to a bicycle seat and further comprising an outer edge and a rear end;
a securing element disposed about the outer edge; and
a storage receptacle connected to the rear end of the bicycle seat cover, the storage receptacle including bicycle attachment means for attaching the storage receptacle to a bicycle adjacent a lower rear portion of a bicycle seat.

2. The bicycle seat cover and integrated storage device of claim 1, wherein the bicycle attachment means comprises a bike bag adapted to be secured to a bicycle adjacent a lower rear portion of a bicycle seat, and wherein the storage receptacle is attached to the bike bag.

3. The bicycle seat cover and integrated storage device of claim 2, wherein the storage receptacle is detachably connected to the rear end of the bicycle seat cover.

4. The bicycle seat cover and integrated storage device of claim 3, wherein the storage receptacle comprises a pocket with a volume sufficient to store the seat cover, the pocket secured to an outer side of a bike bag closure flap, the pocket including an opening through which the seat cover can be removed and inserted from the pocket.

5. The bicycle seat cover and integrated storage device of claim 4, wherein the storage device comprises an outer flap secured to the bike bag closure flap, the outer flap having an open position in which the pocket opening is uncovered, and the outer flap having a closed position in which the pocket opening is covered.

6. The bicycle seat cover and integrated storage device of claim 5, wherein the storage receptacle further comprises an outer edge attached to the rear end of the seat cover.

7. The bicycle seat cover and integrated storage device of claim 1, wherein the storage device comprises a pouch with a volume sufficient to store the seat cover, the pouch comprising an opening through which the seat cover can be removed and inserted from the pouch, the opening including a closure, and wherein the bicycle attachment means comprises means for attaching the pouch directly to a portion of a bicycle behind or below a bicycle seat.

8. The bicycle seat cover and integrated storage device of claim 7, wherein the storage receptacle comprises an outer edge attached to the rear end of the bicycle seat cover.

9. The bicycle seat cover and integrated storage device of claim 7, wherein the opening is a horizontal opening.

10. The bicycle seat cover and integrated storage device of claim 1, wherein the storage receptacle includes bicycle attachment means for attaching the storage receptacle to a bicycle adjacent and below a lower rear portion of a bicycle seat.

11. The bicycle seat cover and integrated storage device of claim 1, wherein the securing element comprises a draw string disposed along the outer edge in a sewn crease with an adjustable clasp located at the front end.

12. The bicycle seat cover and integrated storage device of claim 1, wherein the storage receptacle comprises an opening that allows the seat cover to be entirely inserted and removed from the storage receptacle.

13. The bicycle seat cover and integrated storage device of claim 1, wherein at least a portion of the storage receptacle comprises a breathable material that allows for air circulation so the seat cover can dry.

14. In combination with a bicycle having a seat, a bicycle seat cover and integrated storage device comprising:
a generally seat-shaped bicycle seat cover comprising a flexible material adapted to conform to a bicycle seat and further comprising a narrowing front end, a rear end, and an outer edge;
a securing element disposed about the outer edge; and
a storage receptacle attached to/connected to the rear end of the bicycle seat cover, the storage receptacle including bicycle attachment means for attaching the storage receptacle to a bicycle adjacent a lower rear portion of a bicycle seat.
